(19) United States
(12) Patent Application Publication
(10) Pub. No.: US 2018/0234365 A1
(43) Pub. Date: Aug. 16, 2018

(54) MOBILE DATA TRANSMISSION ENHANCEMENT SYSTEM

(71) Applicant: International Business Machines Corporation, Armonk, NY (US)

(72) Inventors: Lisa Seacat DeLuca, Baltimore, MD (US); Jeremy A. Greenberger, Raleigh, NC (US); Nadiya Kochura, Bolton, MA (US); Fang Lu, Billerica, MA (US)

(21) Appl. No.: 15/434,211

(22) Filed: Feb. 16, 2017

(51) Int. Cl. H04L 12/58; H04W 4/12; H04W 8/24

(52) U.S. Cl. CPC H04L 51/063; H04L 51/10; H04W 8/24; H04W 4/12

(57) ABSTRACT

A mobile data transmission management where a message sender's device queries a receiver's device to determine data remaining of a data quota associated with a time period and associated with a receiver of the message receiver's device. The data remaining for the receiver is categorized based on at least one threshold. When the data remaining for the receiver is less than the at least one threshold, the message sender's device alters a message to be sent to the receiver's device to reduce the data required for the message receiver's device to receive the message. The message sender's device then sends the altered message to the message receiver's device.

### BACKGROUND

The present invention relates to mobile data transmission management, and more specifically to a mobile data transmission enhancement system for mobile data transmission management.

People often share lots of information using their mobile devices. Information can be sent and shared in many different ways. For example, information may be sent via short message service (SMS) or text message, sent as multimedia messages (MMS), email or through other means. The information exchanged may or may not be limited to images or other files. These files may be attached to text messages. Most cellular service providers put a limit on the amount of data a customer can use to share information with other users each month. A sender of a message to a receiver does not know how much of the data the receiver has used of their monthly allotment or monthly data quota. Therefore, if a sender sends a message with a very large attachment, the sender can quickly use up the monthly data quota of the receiver.

### SUMMARY

According to one embodiment of the present invention, a method of mobile data transmission management is disclosed. The method comprising: a message sender's device initiating a message from the message sender's device to send to a message receiver's device; the message sender's device determining data required to receive the message unaltered from the message sender's device; the message sender's device querying data remaining of a time delineated data quota associated with a receiver of the message receiver's device; the message sender's device categorizing the data remaining of the time delineated data quota based on at least one threshold for managing the data remaining of the data quota of the receiver of the message receiver's device; when the data remaining for the receiver is less than the at least one threshold, the message sender's device altering the message to reduce the data required for the message receiver's device to receive the message; and the message sender's device sending the message to the message receiver's device.

According to another embodiment of the present invention, a method of mobile data transmission management is disclosed. The method comprising: a message sender's device initiating a message from the message sender's device to send to a first message receiver's device; the message sender's device determining data required to receive the message unaltered from the message sender's device; the message sender's device querying data remaining of a time delineated data quota associated with a first receiver of the first message receiver's device; the message sender's device categorizing the data remaining of the time delineated data quota based on at least one threshold for managing the data remaining of the data quota of the receiver of the message receiver's device; when the data remaining for the first receiver is less than the at least one threshold, the message sender's device searching for a second receiver authenticated by the first receiver and the sender within a same location as the first message receiver's device; the message sender's device querying a second message receiver's device to determine data remaining of a time delineated data quota associated with the second receiver of the second message receiver's device; and when the data remaining for the second receiver is greater than the at least one threshold, sending the message unaltered from the message sender's device to the second message receiver's device.

According to another embodiment of the present invention, a computer program product for mobile data transmission management is disclosed. The computer program product comprising a computer comprising at least one processor, one or more memories, one or more computer readable storage media, the computer program product comprising a computer readable storage medium having program instructions embodied therewith. The program instructions executable by the computer to perform a method comprising: initiating, by a message sender's device, a message from the message sender's device to send to a message receiver's device; determining, by the message sender's device, data required to receive the message unaltered from the message sender's device; querying, by the message sender's device, data remaining of a time delineated data quota associated with a receiver of the message receiver's device; categorizing, by the message sender's device, the data remaining of the time delineated data quota based on at least one threshold for managing the data remaining of the data quota of the receiver of the message receiver's device; when the data remaining for the receiver is less than the at least one threshold, altering, by the message sender's device, the message to reduce the data required for the message receiver's device to receive the message; and sending, by the message sender's device, the message to the message receiver's device.

According to an embodiment of the present invention, a computer program product for mobile data transmission management is disclosed. The computer program product comprising a computer comprising at least one processor, one or more memories, one or more computer readable storage media, the computer program product comprising a computer readable storage medium having program instructions embodied therewith. The program instructions executable by the computer to perform a method comprising: initiating, by a message sender's device, a message from the message sender's device to send to a first message receiver's device; determining, by the message sender's device, data required to receive the message unaltered from the message sender's device; querying, by the message sender's device, data remaining of a time delineated data quota associated with a first receiver of the first message receiver's device; categorizing, by the message sender's device, the data remaining of the time delineated data quota based on at least one threshold for managing the data remaining of the data quota of the receiver of the message receiver's device; when the data remaining for the first receiver is less than the at least one threshold, searching, by the message sender's device, for a second receiver authenticated by the first receiver and the sender within a same location as the first message receiver's device; querying, by the message sender's device, a second message receiver's device to determine data remaining of a time delineated data quota associated with the second receiver of the second message receiver's device; and when the data remaining for the second receiver is greater than the at least one threshold, sending, by the message sender's device, the message unaltered from the message sender's device to the second message receiver's device.

According to another embodiment of the present invention, a computer system for mobile data transmission management is disclosed. The computer system comprising a computer comprising at least one processor, one or more memories, one or more computer readable storage media having program instructions executable by the computer to perform the program instructions comprising: initiating, by a message sender's device, a message from the message sender's device to send to a message receiver's device;

determining, by the message sender's device, data required to receive the message unaltered from the message sender's device; querying, by the message sender's device, data remaining of a time delineated data quota associated with a receiver of the message receiver's device; categorizing, by the message sender's device, the data remaining of the time delineated data quota based on at least one threshold for managing the data remaining of the data quota of the receiver of the message receiver's device; when the data remaining for the receiver is less than the at least one threshold, altering, by the message sender's device, the message to reduce the data required for the message receiver's device to receive the message; and sending, by the message sender's device, the message to the message receiver's device.

According to another embodiment of the present invention, a computer system for mobile data transmission management is disclosed. The computer system comprising a computer comprising at least one processor, one or more memories, one or more computer readable storage media having program instructions executable by the computer to perform the program instructions comprising: initiating, by a message sender's device, a message from the message sender's device to send to a first message receiver's device; determining, by the message sender's device, data required to receive the message unaltered from the message sender's device; querying, by the message sender's device, data remaining of a time delineated data quota associated with a first receiver of the first message receiver's device; categorizing, by the message sender's device, the data remaining of the time delineated data quota based on at least one threshold for managing the data remaining of the data quota of the receiver of the message receiver's device; when the data remaining for the first receiver is less than the at least one threshold, searching, by the message sender's device, for a second receiver authenticated by the first receiver and the sender within a same location as the first message receiver's device; querying, by the message sender's device, a second message receiver's device to determine data remaining of a time delineated data quota associated with the second receiver of the second message receiver's device; and when the data remaining for the second receiver is greater than the at least one threshold, sending, by the message sender's device, the message unaltered from the message sender's device to the second message receiver's device.

### BRIEF DESCRIPTION OF THE DRAWINGS

FIG. 1 depicts an exemplary diagram of a possible data processing environment in which illustrative embodiments may be implemented.

FIG. 2 shows a flow diagram of a method of data management.

FIG. 3 shows a flow diagram of a method of altering a message to reduce data.

FIG. 4a shows an unaltered message.

FIG. 4b shows an altered message with reduced data.

FIG. 5 illustrates internal and external components of a client computer and a server computer in which illustrative embodiments may be implemented.

FIG. 6 illustrates a block diagram of exemplary system architecture, including a natural language processing system.

### DETAILED DESCRIPTION

In an embodiment of the present invention, a message sender only sends sufficient information to the message receiver to convey the information while being considerate of a receiver's overall data quota limit. Based on the amount of data remaining for the receiver and the type of message being sent from the sender to the receiver, the message is altered to reduce the data being used by the message sent from the sender to the receiver.

For example, the data associated with an original or unaltered message may be reduced if the receiver's data quota is below a threshold by: removing an image or other attachment which is not critical and sending only text; providing a link to a web based image that doesn't need to be downloaded; sending part of the image that is relevant/critical to the message to be conveyed; or sending a selected people's messages based on the message receiver's preference settings. Alternatively, the unaltered message may be sent to another trusted party that is located within a specific area of the originally intended receiver based on the user's preferences. The other trusted party would have an adequate amount of data available to receive the unaltered message. This allows the original message receiver to view the images or other large data from the trusted party's mobile phone.

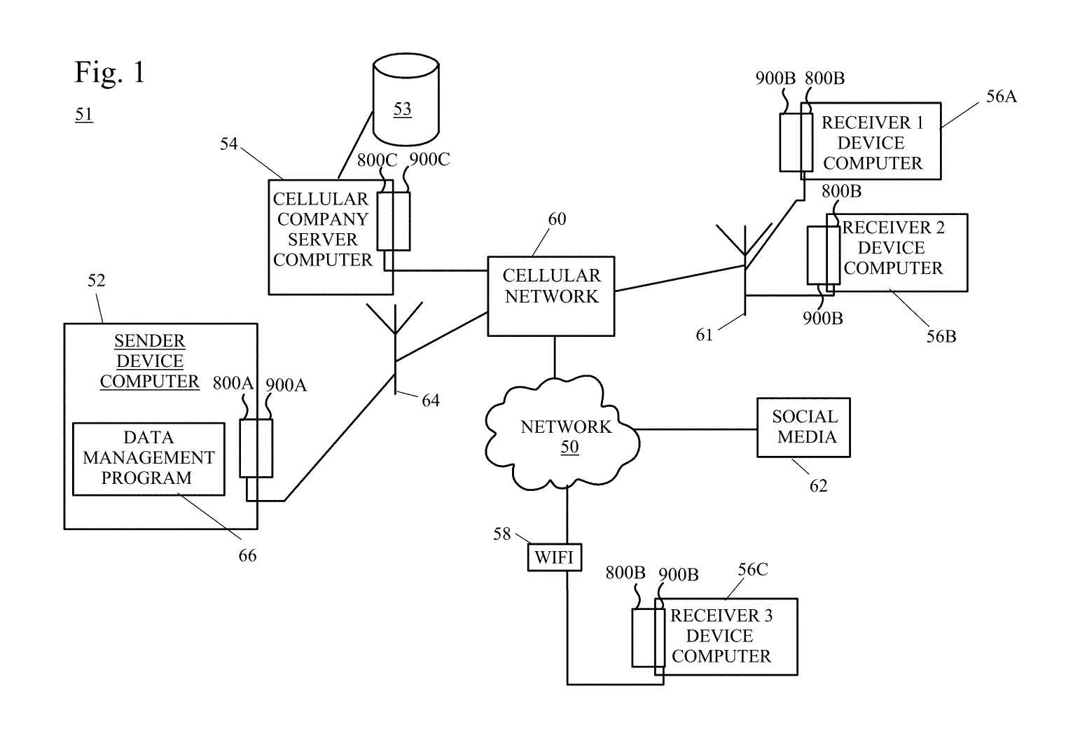

FIG. 1 depicts an exemplary diagram of a possible data processing environment in which illustrative embodiments may be implemented.

It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments of a mobile data enhancement system may be implemented. Network data processing system 51 contains a cellular network 60, and another network 50 which are mediums used to provide communication links between various devices and computers connected together within network data processing system 51. The network 50 may also be used to connect to the cellular network 60, and other devices. The cellular network 60 and the network 50 may include connections, such as wire, wireless communication links, or fiber optic cables.

In the depicted example, a sender device computer 52, a cellular company server 54, and receiver device computers 56a-56c all connect to the cellular network 60. The connection may be via cellular towers 61, 64 or the network 50 via WiFi 58. In other exemplary embodiments, network data processing system 51 may include additional device computers, storage devices or repositories, server computers, cellular towers 61, 64 and other devices not shown.

The network 50 is the Internet representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network 50 also may be implemented as a number of different types of networks, such as, for example, an intranet, local area network (LAN), or a wide area network (WAN). FIG. 1 is intended as an example, and not as an architectural limitation, for the different illustrative embodiments.

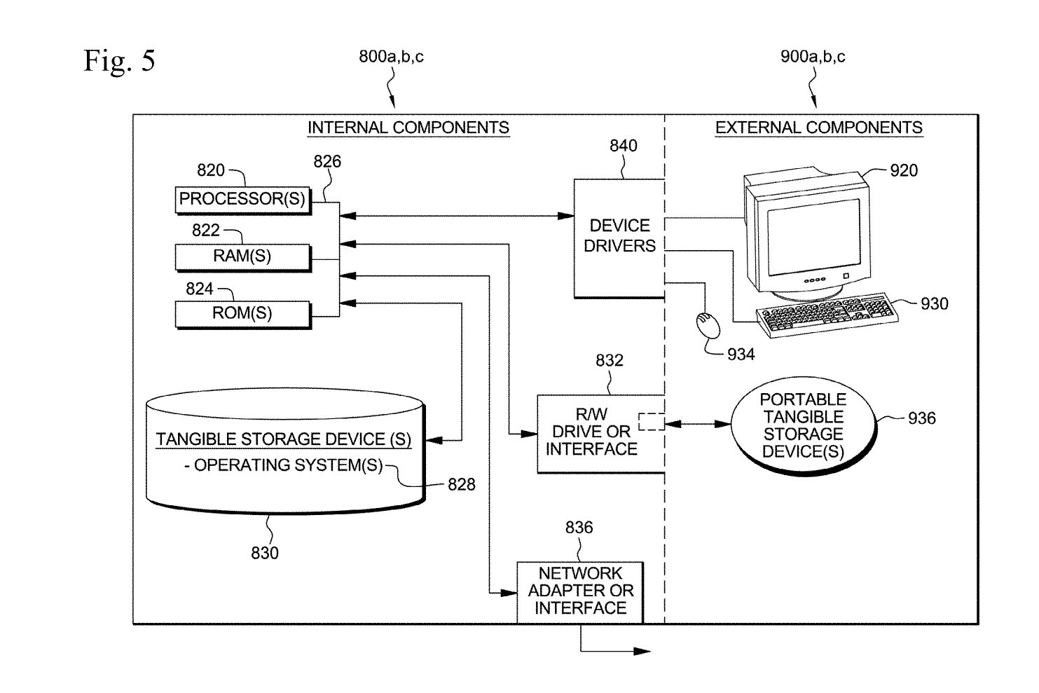

The sender device computer 52 may contain an interface, which may accept commands and data entry from a user. The commands may be regarding a message to be sent to the receiver or input regarding the identification of the receiver of a message. The interface can be, for example, a command line interface, a graphical user interface (GUI), a natural user interface (NUI) or a touch user interface (TUI). The sender device computer 52 preferably includes data management program 66. While not shown, it may be desirable to have the data management program 66 be present on the cellular company server computer 54. The sender device computer 52 includes a set of internal components 800a and a set of external components 900a, further illustrated in FIG. 5. The sender device computer 52 may be a mobile device, smartphone, tablet or other electronic device which can send messages via cellular network 60 or the Internet 50.

The receiver device computers 56a-56c are connected to the cellular network 60. The receiver 1 device computer 56a and the receiver 2 device computer 56b are connected to the cellular network 60 through the cellular tower 61. The receiver 3 device computer 56c is connected to the cellular network 60 through the Internet via WiFi. The receiver device computers 56a-56c include a set of internal components 800b and 800c. The receiver device computers 56a-56c may be a mobile device, smartphone, tablet or other electronic device which can receive messages via cellular network 60 or the Internet 50.

Cellular company server computer 54 includes a set of internal components 800c and a set of external components 900c illustrated in FIG. 5. In the depicted example, cellular company server computer 54 provides information, such as boot files, operating system images, and applications to the sender device computer 52. Cellular company server computer 54 can compute the information locally or extract the information from other computers on cellular network 50. The cellular company server computer 54 is connected to a repository 53. The repository 53 preferably includes information regarding the receivers including, but not limited to, data quotas for a time period and allotment of the data quota used within the time period. The repository 53 may also include information regarding the likes, dislikes, and/or contacts of the users on the cellular network and other information. The server computer 54 may contain the data management program 66.

Social media 62 may be accessible by the sender device computer 52, receiver device computers 56a-56c, and the cellular company server 54 via the Internet 50. Social media 62 may have information regarding the receivers and the sender that may be used for image analysis and semantic analysis discussed in further detail below.

Program code and programs such as the data management program 66 may be stored on at least one of one or more computer-readable tangible storage devices 830 shown in FIG. 5, on at least one of one or more portable computer-readable tangible storage devices 936 as shown in FIG. 5, or on repository 53 connected to cellular network 60, or may be downloaded to a sender device computer 52 or cellular company server computer 54, for use. For example, program code and programs such as data management program 66 may be stored on at least one of one or more storage devices 830 on cellular company server computer 54 and downloaded to sender device computer 52 over cellular network 60 for use or via the Internet 50.

Alternatively, cellular company server computer 54 can be a web server, and the program code, and programs such as data management program 66 may be stored on at least one of the one or more storage devices 830 on cellular company server computer 54 and accessed sender device computer 52. In other exemplary embodiments, the program code, and programs such as data management program 66 may be stored on at least one of one or more computer-readable storage devices 830 on sender device computer 52 or distributed between two or more servers.

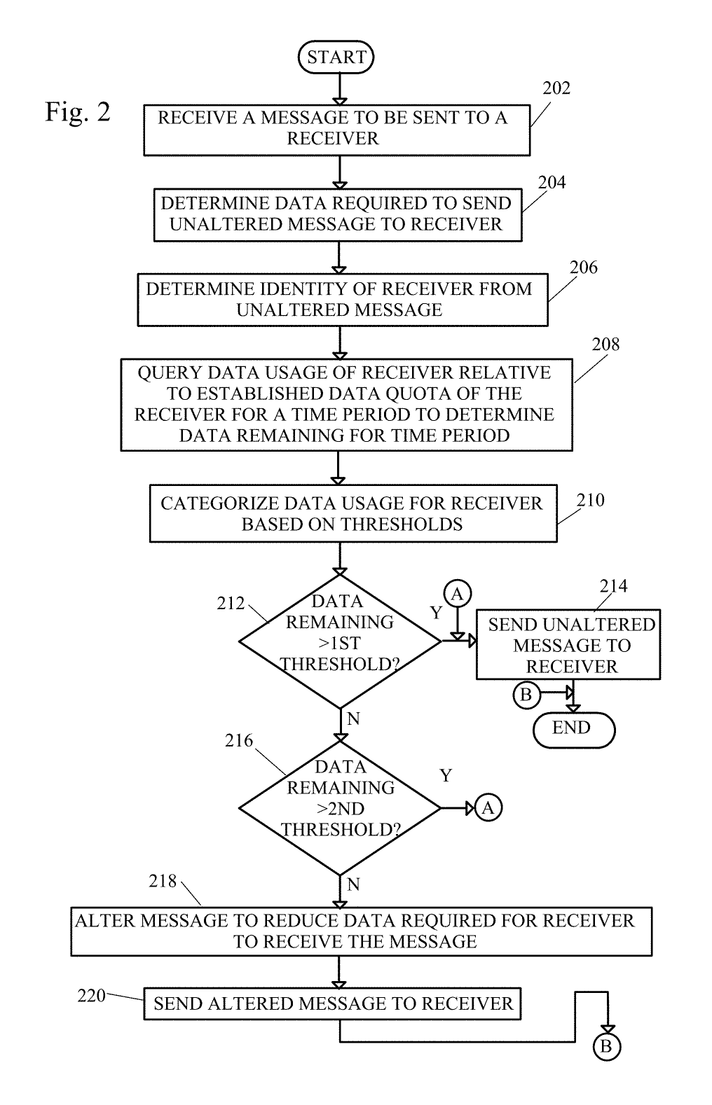

FIG. 2 shows a flow diagram of a method of data management.

In a first step, a data management program 66 of the sender's device computer receives a message initiated by the sender's device computer to be sent to a receiver's device computer (step 202).

The data required to send the entire, unaltered message to the receiver from the sender is determined (step 204), for example through the data management program 66. The data required to send the entire message may be calculated using conventional measuring methods.

The identity of the receiver is determined from the unaltered message (step 206), for example through the data management program 66.

The data management program 66 queries the receiver's cellular company via the cellular company server 54 for the data usage of the receiver relative to the established data quota of the receiver for a time period to determine data remaining for the time period (step 208). Alternatively, the data management program 66 could query the receiver's device computer to determine the amount of data usage remaining. It should be noted that within this step, there may be an identification as to whether the receiver 56a-56c is currently connected to the cellular network 60 via WiFi 58, which does not impact the established data quota of the receiver 56a-56c. If the receiver 56a-56c is connected to the cellular network 60 via WiFi 58, the message from the sender will be sent unaltered as there is no impact to the data quota for the receiver.

The data usage remaining for the receiver of the message is categorized based on thresholds (step 210). The thresholds for the data remaining for a receiver and thus actions regarding the messages from a sender may be set by the receiver or by the cellular company in which data is provided.

For example, if the receiver has 80% of their data remaining, the message may be sent unaltered. If the receiver has 10% of their data remaining, the message can be altered to reduce the data required for the receiver to receive the message and the associated information being sent by the sender as much as possible. Additional categories may also be added, for example if the receiver has 50% of their data remaining, the message can be altered to reduce the data required by a certain amount by the receiver to receive the message.

The receiver may additionally set up rules regarding the amount of data which can be used relative to an expiration of the time period for a specific data quota. For example, if 20% of data remains on the last day of the time period, the receiver may allow all messages, regardless of size, to be sent unaltered.

Furthermore, the user or receiver may set rules to always allow messages to be delivered unaltered from a specific sender.

If the data remaining for the receiver is greater than or equal to a first threshold (step 212), the unaltered message is sent by the sender to the receiver (step 214) and the method ends.

If the data remaining for the receiver is not greater than or equal to the first threshold (step 212), and the data remaining is greater than or equal to a second threshold (step 216), the unaltered message is sent by the sender to the receiver (step 214) and the method ends.

If the data remaining for the receiver is not greater than or equal to the first threshold (step 212) and the data remaining is not greater than or equal to the second threshold (step 216), the message to be sent by the sender to the receiver is altered to reduce the data required by the receiver to receive the message (step 218). The altered message is then sent to the receiver (step 220) and the method ends.

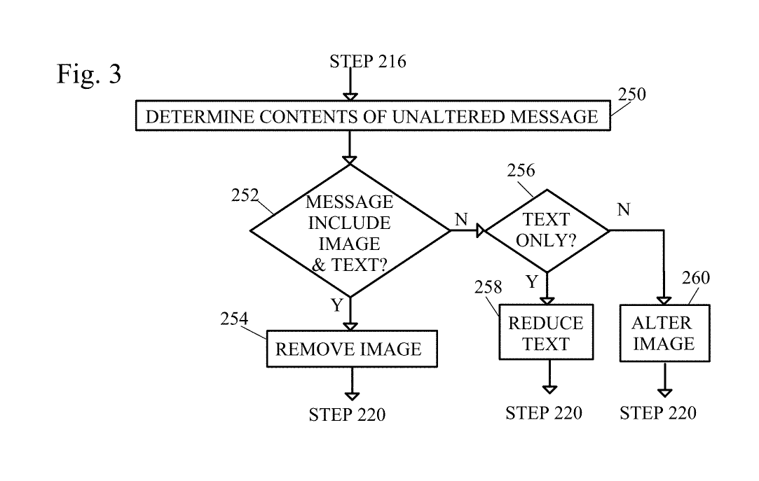

FIG. 3 shows a flow diagram of a method of altering a message to reduce data required by the receiver to receive a message from a sender of step 218.

The data management program determines the contents of the unaltered message being sent by the sender to the receiver (step 250). The contents include the substance of the message as well as the type of message. For example, the type of message may be: text only, image only, or text and image. The substance of the message may be determined by sentiment analysis of a natural language processing system and image or facial recognition. The user may additionally provide information to aid in sentiment analysis, such as likes and dislikes as well as identification of individuals for facial recognition. The additional information may be present within a profile associated with social media or within the cellular company.

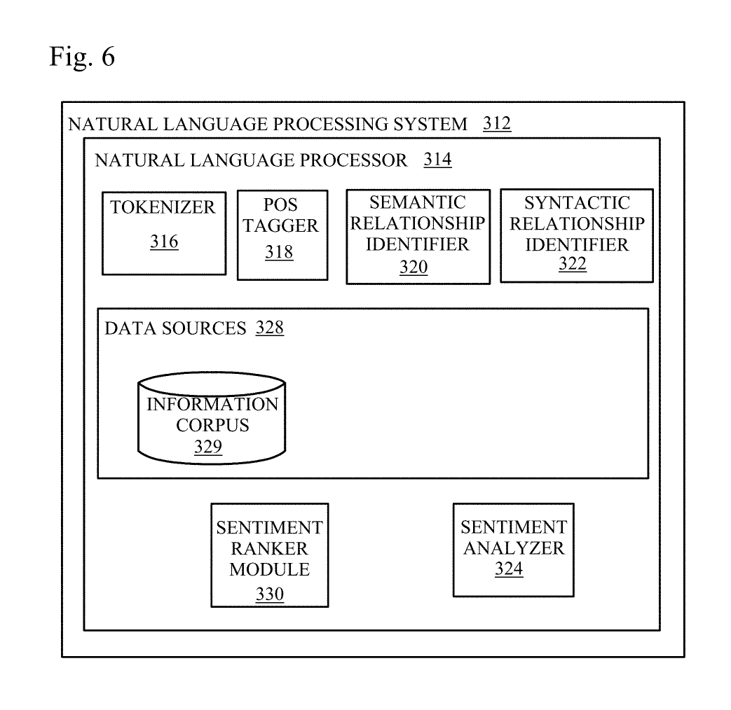

In some embodiments, the natural language processing system 312 may include a natural language processor 312 and a sentiment ranker module 330 as shown in FIG. 6. The natural language processor 312 may include numerous subcomponents, such as a tokenizer, a part-of-speech (POS) tagger, a semantic relationship identifier, and a syntactic relationship identifier. The natural language processing system may be accessible by the sender device computer 52 through the cellular network 60 or the Internet 50.

In some embodiments, the sentiment ranker module 330 may be configured to rank the importance of portions of the message based on an analysis of the sentiment associated with ingested messages. In some embodiments, the natural language processing system may further include a search application (not shown). The search application may be implemented using a conventional or other search engine, and may be distributed across multiple computer systems. The search application may be configured to search one or more databases or other computer systems for information regarding relationships or identification of likes and dislikes of the sender or receiver, for example through social media 62. For example, the search application may be configured to search a corpus of information related to previous submissions to social media 62 in order to identify family members or likes and dislikes.

The natural language processor 314 may be a computer module that analyzes the ingested messages and other electronic documents. The natural language processor 314 may perform various methods and techniques for analyzing electronic documents (e.g., syntactic analysis, semantic analysis, etc.). The natural language processor 314 may be configured to recognize and analyze any number of natural languages. In some embodiments, the natural language processor 314 may parse passages of the message or document. Further, the natural language processor 314 may include various modules to perform analyses of the messages to be sent and other associated files. These modules may include, but are not limited to, a tokenizer 316, a part-of-speech (POS) tagger 318, a semantic relationship identifier 320, a syntactic relationship identifier 322, and sentiment analyzer 324.

In some embodiments, the tokenizer 316 may be a computer module that performs lexical analysis. The tokenizer 316 may convert a sequence of characters into a sequence of tokens. A token may be a string of characters included in an electronic document or message and categorized as a meaningful symbol. Further, in some embodiments, the tokenizer 316 may identify word boundaries in an electronic document or message and break any text passages within the document into their component text elements, such as words, multiword tokens, numbers, and punctuation marks. In some embodiments, the tokenizer 316 may receive a string of characters, identify the lexemes in the string, and categorize them into tokens.

Consistent with various embodiments, the POS tagger 318 may be a computer module that marks up a word in passages to correspond to a particular part of speech. The POS tagger 318 may read a passage or other text in natural language and assign a part of speech to each word or other token. The POS tagger 318 may determine the part of speech to which a word (or other text element) corresponds based on the definition of the word and the context of the word. The context of a word may be based on its relationship with adjacent and related words in a phrase, sentence, or paragraph. In some embodiments, the context of a word may be dependent on one or more previously analyzed electronic documents (e.g., the content of one product review may shed light on the meaning of text elements in another product review, particularly if they are reviews of the same product). Examples of parts of speech that may be assigned to words include, but are not limited to, nouns, verbs, adjectives, adverbs, and the like. Examples of other part of speech categories that POS tagger 318 may assign include, but are not limited to, comparative or superlative adverbs, wh-adverbs, conjunctions, determiners, negative particles, possessive markers, prepositions, wh-pronouns, and the like. In some embodiments, the POS tagger 318 may tag or otherwise annotate tokens of a passage with part of speech categories. In some embodiments, the POS tagger 318 may tag tokens or words of a passage to be parsed by other components of the natural language processing system 312.

In some embodiments, the semantic relationship identifier 320 may be a computer module that is configured to identify semantic relationships of recognized text elements (e.g., words, phrases) in documents. In some embodiments, the semantic relationship identifier 320 may determine functional dependencies between entities and other semantic relationships.

Consistent with various embodiments, the syntactic relationship identifier 322 may be a computer module that is configured to identify syntactic relationships in a passage composed of tokens. The syntactic relationship identifier 322 may determine the grammatical structure of sentences such as, for example, which groups of words are associated as phrases and which word is the subject or object of a verb. The syntactic relationship identifier 322 may conform to formal grammar

Consistent with various embodiments, the sentiment analyzer 324 may be a computer module that is configured to identify and categorize the sentiments associated with tokens of interest. In some embodiments, the sentiment analyzer may be configured to identify, within text passages, and annotate keywords that are preselected as high quality indicators of sentiment polarity (e.g., indicators of positive sentiment could include brilliant, excellent, or fantastic). Various tools and algorithms may be used by the sentiment analyzer 324 as are known to those skilled in the art (e.g., Naïve Bayes lexical model).

In some embodiments, the natural language processor 314 may be a computer module that may parse a document or message and generate corresponding data structures for one or more portions of the document or message. In some embodiments, a parsed text element may be represented in the form of a parse tree or other graph structure. To generate the parsed text element, the natural language processor 314 may trigger computer modules 316-324.

In some embodiments, the output of the natural language processor 314 may be stored as an information corpus 329 in one or more data sources 328. In some embodiments, data sources 328 may include data warehouses, information corpora, data models, and document repositories. The information corpus 329 may enable data storage and retrieval.

In some embodiments, the natural language processing system 312 may include a sentiment ranker module 330. The sentiment ranker module 330 may be a computer module that is configured to generate sentiment scores for specific portions of the ingested message.

In some embodiments, a facial recognition system is used to identify or verify a person or thing from a digital image or a video frame from a video source. For example, the facial recognition system can compare selected facial features from the image with a facial database or a user's profile or social media 62.

In other embodiments, the image recognition system can identify and pick out specific individuals within an image based on a user's profile and alter the image to only contain the specific individuals as found in the user's profile. Furthermore, the image recognition system can replace the image with an image description. In addition the image description can be extended by adding metadata of the image such as location.

If the unaltered message includes image and text (step 252), the image is removed from the message (step 254), resulting in only the text remaining and the method continues to step 220 of sending the altered message to the receiver.

In an alternate embodiment, the image may not be removed, but reduced in size. The reduction in data required to send the image may be executed by reducing the number of pixels comprising the image, increasing the compression of the image, or cropping the image.

If the unaltered message does not include image and text (step 252) and includes text only (step 256), the text can be summarized or only key segment information of the text is selected to be sent to the receiver (step 258) and the method continues to step 220 of sending the altered message to the receiver. The identification of key portions of the text or summarization of the text may be carried out by the natural language processing system 312.

If the unaltered message does not include image and text (step 252) or text only (step 256), the message contains only an image, and the image is altered (step 260). The method then continues to step 220 of sending the altered message to the receiver.

In one embodiment, in order to reduce the data associated with the image, the image can be cropped to reduce the image size. Alternatively, the number of pixels comprising the image may be reduced. In yet another embodiment, the compression of the image may be increased.

In yet another embodiment, the image can be converted such that information within the image can be converted into text, for example through image or facial recognition analysis. One example would be converting a photo of a dog into text stating “dog photo”.

In an alternate embodiment, if the reduction to the message is not enough to prevent the receiver from exceeding their data quota for the time period, the data management program 66 can determine whether there are other users within the same vicinity of the originally intended receiver that are identified as a trusted party or user by both the sender and the receiver. If the trusted party has enough data remaining, the sender can send the unaltered message to the trusted party to share with the original receiver. A notification to the trusted party can be sent providing an explanation regarding the message received.

For example, a message sender just came back from her daughter's dance performance The message sender took a few photos that she wanted to share with her friend, the message receiver, by text message via her mobile device. The message receiver may be receiver 1 device computer 56a of FIG. 1.

A query is sent to the message receiver's mobile device 56a to determine the data quota left. The intended receiver 56a has less than 10 percent of the data quota left for the month.

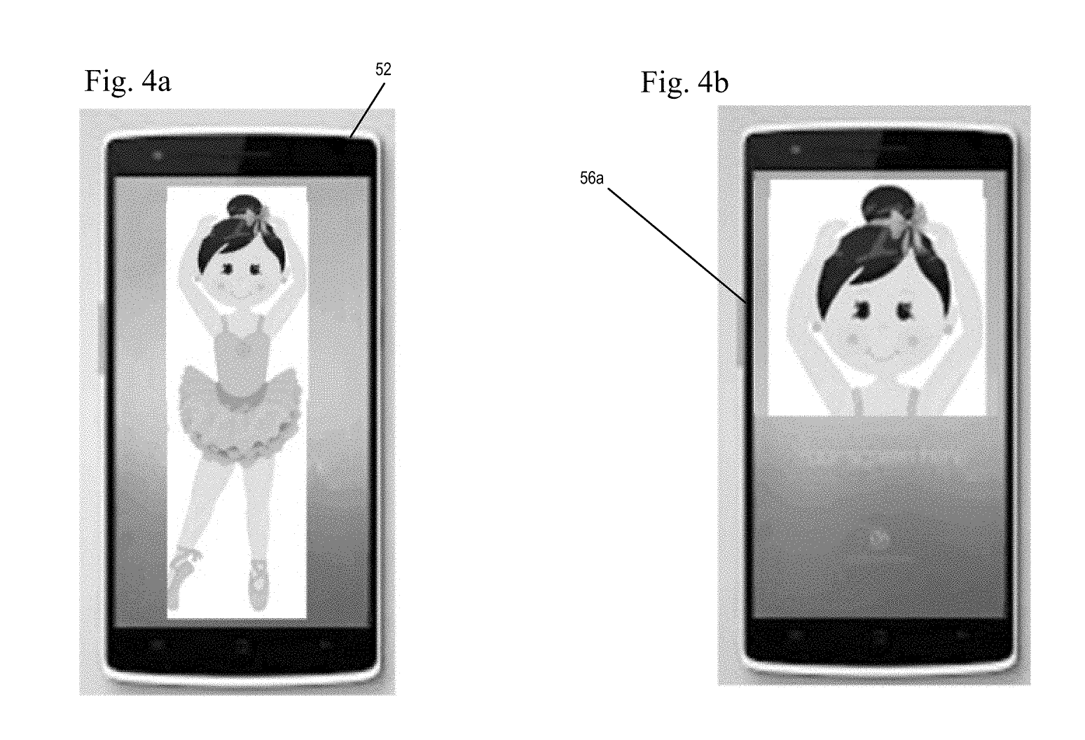

The size of the message to be sent to the message receiver by the message sender is calculated. The size of the image file that the message sender wants to send is too large for message receiver 56a to receive without causing overages of the data quota. An example of the unaltered image to be sent is shown in FIG. 4a.

The data management program 66 of the sender's mobile device 52 scans through the content of the image that the message sender wants to send to determine the type of message being sent (e.g. text only, image only, text and image) as well as the content or what is in the image being sent. Through facial and image analysis, it is determined that the image being sent is of the sender's daughter. The facial and image analysis system compares facial features in the image to a database of known users to the sender. In order to reduce the size of image being sent to the receiver's mobile device 56a, the image is cropped to just show the face of the daughter as shown in FIG. 4b. The image of just the daughter's face is sent to the receiver's mobile device 56a via text message.

In another example, the data management system 66 determines that another receiver, receiver 2 56b is present in the same area as the original receiver, receiver 1 56a. Since receiver 2 56b is identified as a trusted party through social media 62, the data management system 66 initiates sending the full, unaltered image as shown in FIG. 4a to the mobile device 56b of receiver 2. A notification, such as a text message, may be sent to one or both receiver 1 and receiver 2 regarding the full image sent.

In yet another embodiment, if the receiver of the unaltered message from the sender was receiver 3, and the data management system 66 detected that the receiver 3 mobile device 56c is connected to the cellular network 60 via WiFi 58, the unaltered message would be sent to the mobile device 56c regardless of the data remaining of receiver 3's data quota.

FIG. 5 illustrates internal and external components of a sender device computer 52, receiver device computers 56a-56c and cellular company server computer 54 in which illustrative embodiments may be implemented. In FIG. 5, a sender device computer 52, receiver device computer 56a-56c and a cellular server computer 54 include respective sets of internal components 800a, 800b, 800c and external components 900a, 900b, 900c. Each of the sets of internal components 800a, 800b, 800c includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and data management program 66 are stored on one or more of the computer-readable tangible storage devices 830 for execution by one or more of the processors 820 via one or more of the RAMs 822 (which typically include cache memory). In the embodiment illustrated in FIG. 5, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b, 800c also includes a R/W drive or interface 832 to read from and write to one or more portable computer-readable tangible storage devices 936 such as a CD-ROM, DVD, memory stick, magnetic tape, magnetic disk, optical disk or semiconductor storage device. Data management program 66 can be stored on one or more of the portable computer-readable tangible storage devices 936, read via R/W drive or interface 832 and loaded into hard drive 830.

Each set of internal components 800a, 800b, 800c also includes a network adapter or interface 836 such as a TCP/IP adapter card. Data management program 66 can be downloaded to the sender device computer 52, receiver device computers 56a-56c and cellular company server computer 54 from an external computer via a network (for example, the Internet, a local area network or other, wide area network) and network adapter or interface 836. From the network adapter or interface 836, data management program 66 is loaded into hard drive 830.

Data management program 66 can be downloaded to the cellular company server computer 54 from an external computer via a network (for example, the Internet, a local area network or other, wide area network) and network adapter or interface 836. From the network adapter or interface 836, data management program 66 is loaded into hard drive 830. The network may comprise copper wires, optical fibers, wireless transmission, routers, firewalls, switches, gateway computers and/or edge servers.

Each of the sets of external components 900a, 900b, 900c includes a computer display monitor 920, a keyboard 930, and a computer mouse 934. Each of the sets of internal components 800a, 800b, 800c also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Data management program 66 can be written in various programming languages including low-level, high-level, object-oriented or non object-oriented languages. Alternatively, the functions of a data management program 66 can be implemented in whole or in part by computer circuits and other hardware (not shown).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method of mobile data transmission management comprising:
a message sender's device initiating a message from the message sender's device to send to a message receiver's device;
the message sender's device determining data required to receive the message unaltered from the message sender's device;
the message sender's device querying data remaining of a time delineated data quota associated with a receiver of the message receiver's device;
the message sender's device categorizing the data remaining of the time delineated data quota based on at least one threshold for managing the data remaining of the data quota of the receiver of the message receiver's device;
when the data remaining for the receiver is less than the at least one threshold, the message sender's device altering the message to reduce the data required for the message receiver's device to receive the message; and
the message sender's device sending the message to the message receiver's device.

2. The method of claim 1, wherein when the data remaining for the receiver is greater than the at least one threshold, the message sender's device sends the message unaltered to the message receiver's device.

3. The method of claim 1, wherein the threshold is set by a user of the message receiver's device.

4. The method of claim 1, wherein the step of the message sender's device altering the message to reduce the data required for the message receiver's device to receive the message further comprises the message sender's device:
determining contents of the message unaltered; and
altering the contents of the message.

5. The method of claim 1, wherein the contents of the message are altered by removing an image within the message.

6. The method of claim 1, wherein the contents of the message are altered by reducing the text within the message through summarization.

7. The method of claim 1, wherein the contents of the message are altered by altering the image.

8. The method of claim 7, wherein the image is altered by cropping the image to show images relevant to the sender or the receiver.

9. A method of mobile data transmission management comprising the steps of:
a message sender's device initiating a message from the message sender's device to send to a first message receiver's device;
the message sender's device determining data required to receive the message unaltered from the message sender's device;
the message sender's device querying data remaining of a time delineated data quota associated with a first receiver of the first message receiver's device;
the message sender's device categorizing the data remaining of the time delineated data quota based on at least one threshold for managing the data remaining of the data quota of the receiver of the message receiver's device;
when the data remaining for the first receiver is less than the at least one threshold, the message sender's device searching for a second receiver authenticated by the first receiver and the sender within a same location as the first message receiver's device;
the message sender's device querying a second message receiver's device to determine data remaining of a time delineated data quota associated with the second receiver of the second message receiver's device; and
when the data remaining for the second receiver is greater than the at least one threshold, sending the message unaltered from the message sender's device to the second message receiver's device.

10. The method of claim 9, further comprising the message sender's device sending a message to the second message receiver's device with instructions to the second receiver to share the message unaltered with the first receiver.

11. A computer program product for mobile data transmission management stored in a computer readable medium which includes a computer comprising at least one processor, one or more memories, one or more computer readable storage media, the computer program product comprising a computer readable storage medium having program instructions embodied therewith, the program instructions executable by the computer to perform a method comprising:
initiating, by a message sender's device, a message from the message sender's device to send to a message receiver's device;
determining, by the message sender's device, data required to receive the message unaltered from the message sender's device;
querying, by the message sender's device, data remaining of a time delineated data quota associated with a receiver of the message receiver's device;
categorizing, by the message sender's device, the data remaining of the time delineated data quota based on at least one threshold for managing the data remaining of the data quota of the receiver of the message receiver's device;
when the data remaining for the receiver is less than the at least one threshold, altering, by the message sender's device, the message to reduce the data required for the message receiver's device to receive the message; and
sending, by the message sender's device, the message to the message receiver's device.

12. The computer program product of claim 11, wherein when the data remaining for the receiver is greater than the threshold, sending, by the message sender's device, the message unaltered to the message receiver's device.

13. The computer program product of claim 11, wherein the threshold is set by a user of the message receiver's device.

14. The computer program product of claim 11, wherein the program instructions of altering, by the message sender's device, the message to reduce the data required for the message receiver's device to receive the message further comprises the program instructions of:
determining, by the message sender's device, contents of the message unaltered; and
altering, by the message sender's device, the contents of the message.

15. The computer program product of claim 11, wherein the contents of the message are altered, by the message sender's device, by removing an image within the message.

16. The computer program product of claim 11, wherein the contents of the message are altered, by the message sender's device, by reducing the text within the message through summarization.

17. The computer program product of claim 11, wherein the contents of the message are altered, by the message sender's device, by altering the image.

18. The computer program product of claim 17, wherein the image is altered by, by the message sender's device, cropping the image to show images relevant to the sender or the receiver.
